(19) United States
(12) Patent Application Publication
(10) Pub. No.: US 2026/0256041 A1
(43) Pub. Date: Sep. 3, 2026

(54) TOOL BLOCK FOR AN AGRICULTURAL MACHINE, AGRICULTURAL MACHINE PROVIDED WITH A TOOL BLOCK OF THIS KIND, AND METHOD FOR ADJUSTING THE TOOL BLOCK

(71) Applicant: NAÏO-TECHNOLOGIES, ESCALQUENS (FR)

(72) Inventors: Bruno MATHIEU, CASTANET (FR); Clément FRAISIER VANNIER, LACROIX-FALGARDE (FR); Denis MOINDRAULT, MAUREMONT (FR); Gaëtan SÉVERAC, TOULOUSE (FR); Aymeric BARTHES, FLOURENS (FR)

(21) Appl. No.: 18/713,246

(22) PCT Filed: Nov. 24, 2022
(86) PCT No.: PCT/EP2022/083148

§ 371 Date: May 24, 2024

(30) Foreign Application Priority Data
Nov. 25, 2021 (FR) 2112498

(51) Int. Cl. A01B 63/00; A01B 76/00

(52) U.S. Cl. CPC A01B 63/004; A01B 76/00

(57) ABSTRACT

A tool block for an agricultural machine, including: a plurality of tools, each carried by a tool holder able to slide on a support rail; a central control system with microprocessor(s); a human-machine interface configured to enable a user to enter a usage configuration defining the tools to be used from among the plurality of tools of the tool block as well as a target position on the support rail for each of the tools to be used, the tool block including position-determining means for determining the position of each tool holder relative to the support rail, and motorised drive means, configured to individually move each tool holder along the support rail and directly or indirectly controlled by the central control system.

### CROSS REFERENCE TO RELATED APPLICATIONS

This application is a National Stage of International Application No. PCT/EP2022/083148, having an International Filing Date of 24 Nov. 2022, which designated the United States of America, and which International Application was published under PCT Article 21(2) as WO Publication No. 2023/094532A1, which claims priority from and the benefit of French Patent Application No. 2112498 filed on 25 Nov. 2021, the disclosures of which are incorporated herein by reference in their entireties.

### BACKGROUND

### Field

The present application relates to the field of agricultural machines used in fields for the production and/or maintenance (mechanical weeding, for example) and/or harvesting of vegetable crops.

More particularly, the disclosure relates to the field of straddle robots for low industrial vegetable crops (vegetables in general) in sheets. By “sheet”, it should be understood a series of several parallel rows of crops, generally dedicated to one single crop in particular. The expression “straddle robot” means that the wheels of the robot lie on either side of the sheet and that the body of the robot overhangs the sheet. A straddle robot for sheet cropping is configured to overhang a sheet (its wheels are located on either side of the sheet) or possibly several sheets, and to work between the rows of the sheet that it overhangs or on the rows themselves, for example between the plants of each row of the sheet.

### Brief Description of Related Developments

Such a robot usually comprises a portion dedicated to the traction or propulsion of the robot, a portion dedicated to steering of the robot and a tool block generally positioned at the central portion of the robot, the tool block being carried by a fixed axle with which the guidance system of the robot (including a GPS) is associated so that the positioning of the tool block relative to the crops is as accurate as possible.

In the case of a robot for industrial cultures in sheets, the tool block includes a plurality of tools distributed according to the transverse direction of the robot, which transverse direction is orthogonal to the direction of movement of the robot. The tools are distributed transversely so that each tool is for example positioned between two rows of the sheet. For example, for a ten-row sheet, the tool block may be equipped with eleven ploughs or weeding knives intended to tear off undesirable plants that have grown between the rows. The spacing between the knives should be carefully adjusted so that the knives do not damage the plants cultivated in the rows.

In general, weeding vegetable crops in sheets is a service that the agricultural operators purchase at a subcontractor company which has the appropriate robot.

Yet, not all crops in sheets have the same dimensions. Depending on the cultivated plant or for other reasons, the number of rows per sheet and above all the space between the rows vary from one crop to another, and even from one field to another.

Hence, between two interventions of the robot, the configuration of the tool block, in particular the number and the positioning of the tools, should be redefined and adjusted according to the next field to be treated, which leads to an immobilisation of the robot which is detrimental to profitability thereof for the subcontractor company that operates the robot. What is more, to date, the adjustment of the tool block (in particular, the positioning of the tools) is performed manually and is therefore particularly long and expensive in terms of downtime and labour. Furthermore, positioning errors might occur, with the risk of damaging a crop.

### SUMMARY

The disclosure aims to overcome at least one of the aforementioned drawbacks by providing a tool block the adjustment of which is performed easily, quickly and without error, in order to improve the profitability of the agricultural machines equipped with such a tool block.

For this purpose, the disclosure provides a tool block for an agricultural machine (the latter may be robotic or not), the tool block having an axial direction intended to coincide with a direction of movement of the agricultural machine, and a transverse direction according to which a width of the tool block is defined, this transverse direction of the tool block being intended to coincide with a transverse direction of the agricultural machine orthogonal to the axial direction of movement of the agricultural machine, the tool block comprising:
a plurality of tools,
for each tool, a tool holder on which the tool is mounted,
a support rail extending according to the transverse direction, on which the tools can be mounted via their respective tool holder, which tool holder comprises means for coupling to the support rail enabling a movement of the tool holder relative to the support rail according to the transverse direction (which is also the longitudinal direction of the support rail),

The tool block according to the disclosure is characterised in that it comprises:
a central control system with microprocessor(s),
a human-machine interface connected to the central control system and configured to enable a user to select a usage configuration defining tools to be used among the plurality of tools of the tool block, as well as a target position on the support rail for each of the tools to be used,
the tool block comprises motorised drive means configured to move each tool holder individually according to the transverse direction on the support rail, the motorised drive means being controlled, directly or indirectly, by the central control system,
position-determining means for determining the position of each tool holder relative to the support rail according to the transverse direction.

According to a possible feature of the disclosure, the support rail includes:
a first end, so-called the loading end, and a first section, so-called the loading section, by which the plurality of tool holders can be loaded onto the support rail, as well as an opposite end, so-called the parking end,
a working central section, on which the tool holders of the tools to be used can be driven and positioned according to the selected usage configuration, using the motorised drive means and the position-determining means,
a parking lateral section extending from the parking end of the support rail, on which unused tools among the plurality of tools can be stored, i.e. placed aside and neutralised waiting for a possible future use.

Preferably, the support rail comprises two parking lateral sections (one on each side of the working central section), i.e. a section starting from the parking end and a section starting from the loading end of the support rail. In this case, any feature described for a parking lateral section could be applied, unless stated otherwise, to the two parking lateral sections.

Various aspects are possible for the motorised drive means. According to a first possible aspect, the motorised drive means comprise a fixed chain which extends according to the transverse direction and is integrated to the support rail, as well as, for each tool holder, a pinion adapted to engage the fixed chain of the support rail for the purpose of moving the tool holder along the support rail.

In a first possible version of this aspect, wherein the tool holder is said active, the motorised drive means further comprise, for each tool holder, a motor configured to drive in rotation a motor shaft on which the pinion of the tool holder is fastened.

As indicated before, the motorised drive means, and in particular the motor of each tool holder, can be controlled directly by the central control system. Alternatively, the motorised drive means, and in particular the motor of each tool holder, can be indirectly controlled by the central control system, as follows:
the tool block comprises, for each tool, an individual control board with microprocessor(s), housed in the tool holder on which the tool is mounted, and in which an identifier of the tool is memorised, said individual control board being connected to the central control system of the tool block, for example via a wired link,
the position-determining means comprise a calculation module integrated into the individual control board of each tool holder.

Moreover, according to a possible feature, the position-determining means comprise one or more sensor(s) located on the support rail and/or on each tool holder.

For example, the position-determining means comprise, for each tool holder, a SINCOS sensor configured to transmit to the individual control board of the tool (if the tool holder has one) or to the central control system measurement data representative of an angle formed by a marking axis of the pinion with a fixed reference axis orthogonal to the motor shaft, the individual control board of the tool and/or the central control system being configured to calculate a number of complete revolutions and revolution fractions performed by the shaft motor from a gear position or from a previously memorised position and to deduce therefrom a current position of the tool holder relative to the support rail.

According to one possible feature of the disclosure, the loading end of the support rail is chamfered in order to facilitate loading of the tool holders on the support rail.

According to a possible feature of the disclosure, the means for coupling each tool holder to the support rail comprise a bracket having a coupling opening having a section complementary to a nominal section of the support rail, the coupling aperture being equipped with rollers (or bearings) to enable movement of the bracket along the support rail. Preferably, these rollers comprise one or more fixed roller(s) and an adjustable roller, the radial position of which relative to the rail is adjustable and which is subjected to a centripetal return force relative to the rail. This adjustable roller (there may possibly be several ones) allows, on the one hand, compensating for possible variations in the section of the support rail due to a design defect or to wear, and, on the other hand, applying a force clamping the tool holder on the support rail guaranteeing a rigid hold of the tool holder on the support rail during work.

According to a possible feature of the disclosure in the case where the drive means comprise a fixed chain on the support rail, which fixed chain has a first end, so-called the engaging end, on the side of the loading end of the support rail and an opposite end, so-called the parking end, the position-determining means comprise, on the one hand, a proximity detector (for example an inductive detector) on each tool holder and, on the other hand, at the engaging end of the chain, a sensitive element able to be detected by the proximity detector of each tool holder. Hence, these inductive proximity detectors and the associated sensitive element allow detecting the passage of a tool holder on the engaging end of the chain, i.e. engaging of the tool holder on the chain if the latter was previously outside the chain or disengagement of the tool holder if the latter was previously on the chain.

Advantageously, the sensitive element forms a reference for any positioning calculation. The computing module of the individual control board of the tool holder or that of the central control system is then configured to calculate the number of revolutions (complete or not) performed by the motor shaft of the tool holder as of the detection of the sensitive element, i.e. since engaging of the pinion on the fixed chain, based on the measurement data supplied by the SINCOS sensor; the computing module is configured to deduce therefrom the current position of the tool holder.

The individual control board of each tool holder comprises a non-volatile memory, in which the number of revolutions and the current angle are permanently stored. Thus, in the event of a loss of power supply, it is possible to restore the absolute position of the tool holder on the support rail.

According to a possible feature of the disclosure, each tool holder includes an end-of-travel sensor or switch on an upstream lateral face of the tool holder, said upstream lateral face being oriented towards the parking end of the support rail.

According to a possible feature of the disclosure, each tool holder includes means for adjusting the position of the tool in height relative to the tool holder (and therefore relative to the support rail). Preferably, this adjustment is manual. Alternatively, it is possible to provide for motorised automatic adjustment means, yet to the detriment of the weight, of the bulk and of the cost of the tool holder.

The disclosure covers a method for adjusting a tool block of an agricultural machine, characterised in that a tool block as previously defined is used, and in that:
a usage configuration is selected by a user via the human-machine interface, this usage configuration defining, on the one hand, tools (and therefore tool holders) to be used from among the plurality of tools of the tool block and, on the other hand, a target position on the support rail for each tool to be used,
the central control system controls the motorised drive means to move each tool holder to be used individually up to its target position.

For example, if each tool holder is equipped with a motor and an individual control board, the central control system transmits to the individual control board of each of the tools to be used the target position of the considered tool, and the individual control board controls the motor according to the target position and a current position of the tool holder determined using the position-determining means.

The individual control board determines the current position of the tool holder according to a lastly memorised position and a history of movement listing the complete revolutions and revolution fractions of the motor shaft from this lastly memorised position, thanks to the measurement data supplied by the SINCOS sensor.

The individual control board controls the motor of the tool holder so as to move the tool holder up to the target position, with regards to the current position of the tool holder.

### BRIEF DESCRIPTION OF THE FIGURES

The disclosure, according to one aspect, will be clearly understood and its advantages will appear better upon reading the following detailed description, given for indicative and non-limiting purposes, with reference to the appended drawings wherein:

FIG. 1 is a schematic perspective view of an aspect of a tool block according to the disclosure;

FIG. 2 is a schematic profile view of a tool holder (with a tool) of the tool block of FIG. 1;

FIG. 3 is a schematic perspective view of an element (in this case a motor block) of the tool holder of FIG. 3; and

FIG. 4 is a schematic perspective view of an element (in this case a bracket) of the tool holder of FIG. 3.

### DETAILED DESCRIPTION

The identical elements shown in the aforementioned figures are identified by identical reference numerals.

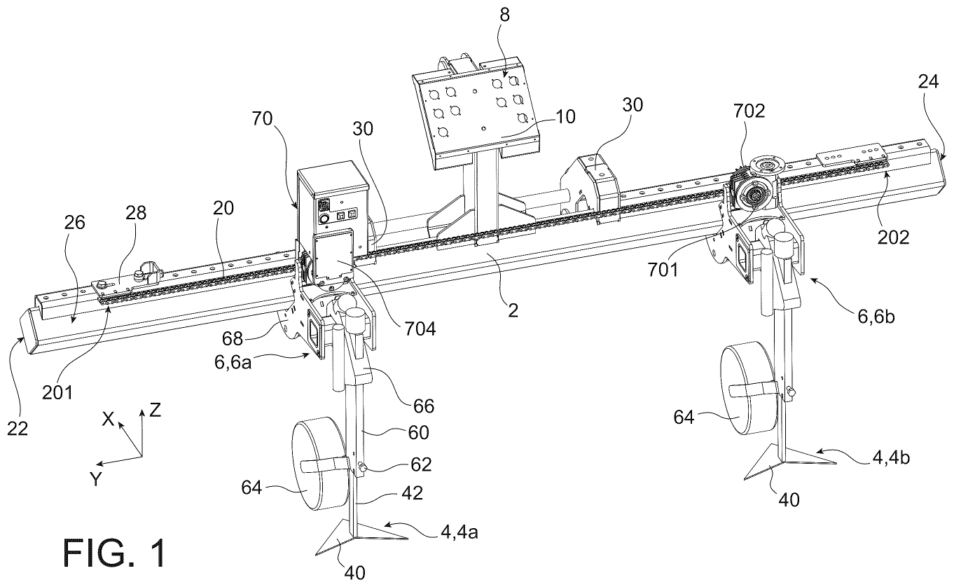

FIG. 1 shows a tool block for an agricultural machine, according to a first aspect of the disclosure. This tool block comprises a support rail 2 extending mainly according to a longitudinal direction Y which coincides with a transverse direction of the agricultural machine when the tool block is installed on an agricultural machine. The tool block comprises fastening elements 30 for fastening thereof to a carrier axle of the agricultural machine.

In addition, the tool block comprises a plurality of tools 4 each carried by a tool holder 6. For clarity, only two tools 4a, 4b (and their respective tool holder 6a, 6b) are shown herein. Each tool comprises a working element, herein a plough 40 for weeding between the rows of a sheet of low vegetable crops. The plough 40 is carried by a support rod 42 to which it is fastened.

The tool holder 6 comprises a vertical tubular bar 60 in which the support rod 42 of the tool can slide. The telescopic assembly 60+42 formed by the tubular bar 60 of the tool holder and the support rod 42 of the tool allows presetting the position of the working element of the tool (i.e. the plough 40) in height, for example, according to the considered tool type. Indeed, depending on its function, the working element of the tool should be at the surface of the ground or at a given distance above it, at the height of the crops, or at a given distance below the surface of the ground. In addition, the illustrated tool holder comprises a guide wheel 64 which immediately precedes the plough when the agricultural machine advances. The height of the surface of the ground is given by the rolling surface of the guide wheel 64. Once the pre-setting has been performed, the telescopic assembly 60+42 is blocked using a screw 62.

The guide wheel 64, the height of which is fixed relative to the tubular bar 60, allows adjusting in real-time the height of the working element 40 of the tool according to the encountered terrain. To this end, the tubular bar 60 which carries the plough 40 and the guide wheel 64 is slidably mounted in a sleeve 66 of the tool holder.

The previously-described elements of the tool 4 and of the tool holder 6 are known to a person skilled in the art. One of the advantages of the disclosure is actually to be able to use, in the context of the disclosure, existing tools and tool holders, commercially available, without having to modify them.

In addition, the tool holder according to the disclosure includes a bracket 68 for connection thereof to the support rail 2. The bracket 68 has, on a first side, an aperture 680 for fastening thereof to the sleeve 66 via a square axis 682 which also passes through two lateral tabs of the sleeve 66. The bracket 68 has, on the opposite side, a calliper 684 for mounting thereof on the support rail 2.

As illustrated, the support rail 2 may have a square cross-section, in which case the calliper 684 forms a coupling opening 686 with a square section slightly larger than the section of the support rail, by which the tool holder 6 could be fitted onto the support rail 2. In addition, the bracket 68 comprises rollers facilitating sliding of the tool holder along the support rail. In the illustrated example, these rollers are in the form of four carriages with needle rollers (cf. FIG. 4), including three fixed carriages 688 and an adjustable carriage 690. Each carriage is carried by a crosspiece connecting two flanges 692 of the calliper. The castors or balls of the four carriages are intended to roll on the four faces of the support rail 2, respectively.

The calliper 684, the opening 686 and the four carriages 688, 690 form means for coupling the tool holder 6 to the support rail 2 enabling a movement of the tool holder relative to the support rail according to the transverse direction (i.e. according to the longitudinal direction of the support rail).

The support rail 2 has a first end 22, so-called the loading end, by which the tool holders (and their tools) can be loaded on the support rail and an opposite end 24, so-called the parking end.

The support rail 2 integrates a fixed chain 20 which extends according to the longitudinal direction of the support rail (transverse direction of the agricultural machine equipped with the tool block) over the entire length of the rail with the exception of a loading section 26 on the side of the loading end 22, which allows properly positioning the tool holder upon loading thereof, before coupling thereof to the chain 20.

A tensioner 28 is provided to be able to adjust the tension of the chain.

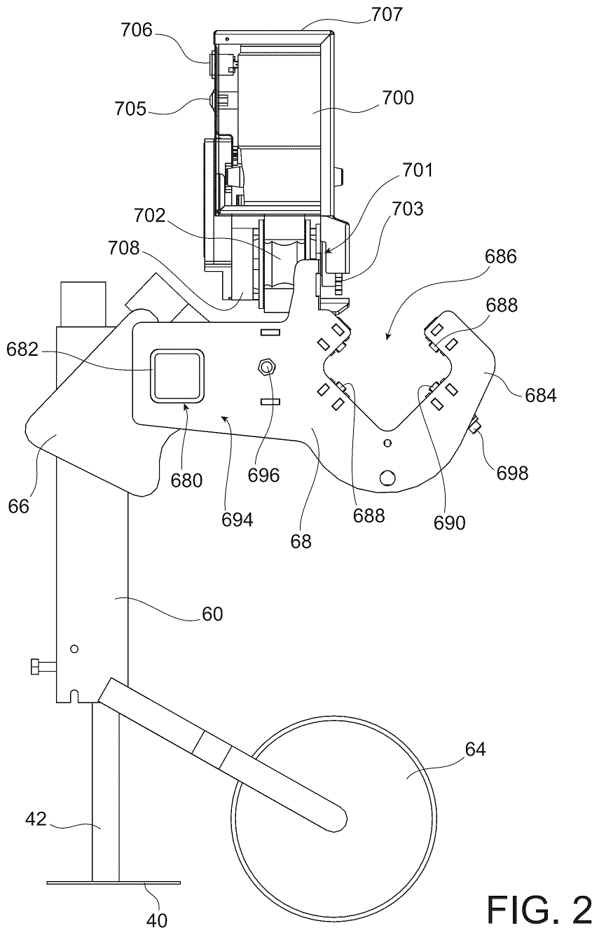

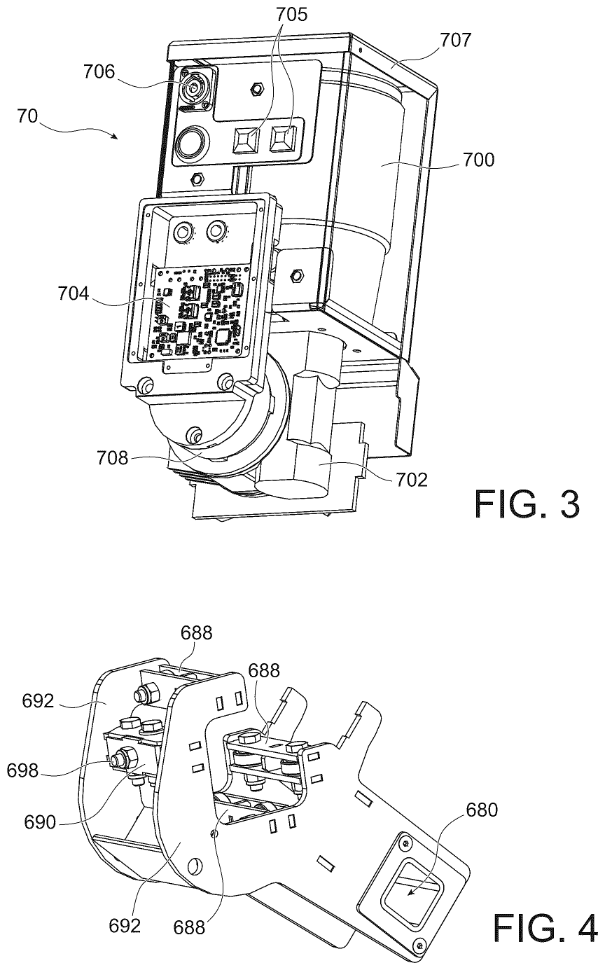

Moreover, each tool holder comprises: a motor block 70 comprising a motor 700, a motor shaft 701, a reducer 702, a pinion 703 (cf. FIG. 2); an individual control board 704 with microprocessor(s); various switches 705, including a button for selecting the operating mode, a right turn button and a left turn button enable a user to move the tool holder at will when needed, independently of the automatic setting performed by the central control system; various connectors 706; a cowl 707, a portion of which is torn off on the tool holder 6a of FIG. 1. It should be noted that some elements (including the cowl, the motor, the individual control board, the switches) have not been shown for the motor block of the tool holder 6b in order to better show the reducer 70. It should be noted that the aforementioned buttons and switches are part of the claimed human-machine interface.

The fixed chain 20 of the support rail and the motor block 70 (in particular the motor 700 and the pinion 702) of each tool holder form motorised drive means configured to move each tool holder individually according to the transverse direction on the support rail, the motorised drive means being controlled, directly or indirectly by a central control system 8 described hereinafter.

In addition, the tool block according to the disclosure comprises position-determining means for determining the position of each tool holder relative to the support rail according to the transverse direction. For example, each tool holder comprises a magnetic spacer, secured to the motor shaft 701 and a sensor magnet (not visible in the figures), these elements forming a SINCOS sensor 708 allowing calculating the number of complete revolutions and/or revolution fractions completed by the pinion 703 in each of the two directions from the engaging end 201 of the chain, the individual control board 704 of the tool holder or the central control system 8 being configured to deduce therefrom a current position of the tool holder relative to the support rail.

In addition, the tool block comprises the aforementioned central control system 8. For example, the latter comprises a microprocessor board (not visible in the figures) integrated into a case surmounting the support rail, as well as a human-machine interface, connected to the central control system.

In the illustrated example, the tool block further comprises a connection plate 10 with holes receiving connectors (not shown) for connecting the movable tool holders using coiled cables (power supply and communication cord).

The central control system 8 is connected to the individual control boards 704 of all tool holders present on the support rail, via a wired connection (not visible in the appended diagrams) or by any suitable wireless means.

The human-machine interface may comprise elements carried by a fixed portion of the tool block (like the support rail) and elements carried by the movable tool holders. The human-machine interface may comprise a display screen (not shown), possibly a touchsceen. In any case, the human-machine interface comprises input means to enable a user to enter a usage configuration defining tools to be used from among the plurality of tools of the tool block as well as a target position on the support rail for each of the tools to be used.

To define a usage configuration, the user enters, for example, the total width of the sheet of crops to be worked, the number of rows that the sheet contains, the type of work to be performed (depending on whether it is a work between the rows of crops, like weeding, or a work on the rows themselves, or else a “mixed” work where the tool intervenes both between the rows and between the plants on the rows). These three pieces of input information enables the central control system to calculate the distance between the rows, which also corresponds to the distance between the inter-row lines, the number of tools to be used and the position that the tools should have on the support rail, each tool then being assigned a target position.

Before first use of the tool block, a loading mode may be selected via the human-machine interface, for the initial loading of the tool holders (with their tool). Once this mode is selected, the user should install a plurality of tool holders (with their tool) on the support rail.

To do so, for each tool holder to be loaded, the loading end 22 of the support rail is fitted into the opening 686 of the bracket 68 of the tool holder, then the position of the tool holder placed on the loading section 24 of the support rail is adjusted. Where necessary, the radial position of the adjustable carriage 690 is adjusted in particular using an adjustment screw 698 so that its rollers press well against the face of the support rail located opposite thereto and exert on this face one pressure guaranteeing proper retention of the tool holder on the support rail without preventing sliding thereof along said support rail.

Where appropriate, the connecting wire is connected between the central control system 8 and the individual control board 704 of the tool holder. This connection triggers the transfer of information from the individual control board to the central control system, which information comprise at least one identification reference of the tool present on the tool holder (this reference allowing individually identifying the tool as well as knowing which is its nature).

Afterwards, the tool holder is pushed towards the engaging end 201 of the chain 20 so as to engage the pinion 703 with the fixed chain 20. A sensor provided on the tool holder detects the engaging end 201 of the chain or engaging of the pinion on the chain, which triggers, on the one hand, start-up of the motor 700 to move the tool holder towards the opposite end of the rail and, on the other hand, control of the position of the tool holder by the individual control board 704, by means of the SINCOS sensor formed by the magnetic spacer 708 and the associated sensor magnet.

In the loading mode, the central control system 8 and/or the individual control board 704 are configured so that, as soon as engaging of the piston on the chain is detected, the motor 700 is activated so as to move the tool holder towards the parking end 24 of the rail. If this is the first tool holder loaded on the support rail, the latter is moved up to the parking end 202 of the chain 20 (the end opposite the engaging end 201). If the tool holder is not the first one to be loaded, it is moved towards the parking end 202 until it comes into abutment against a previously loaded tool holder; to this end, for example, an upstream lateral face 694 of the bracket 68 of the tool holder is provided with an end-of-travel sensor or switch 696 (cf. FIG. 2), the activation of which causes stoppage of the motor 700.

Thus, a plurality of tool holders 6 are loaded on the support rail 2.

When a usage configuration is selected via the human-machine interface as explained hereinabove, the central control system 8 selects the tool holders to be used, calculates the target position of each of the selected tool holders, transmits the target position of each selected tool holder to the control board 704 of the considered tool holder, and successively sends the individual boards of the selected tool holders the command to control the movement of the tool holder up to its target position. In addition, the central control system transmits to the individual boards of each of the unused tool holders (if any) the command to control the movement of said tool holder up to a parking location located either on the parking end 202 side, or on the engaging end 201 side. Of course, the tool holders not used for the upcoming work are selected from among the tool holders the closest to the ends.

It should be noted that, to the extent that it is non-reversible, the reducer 702 of the motor block also serves as means for locking the pinion allowing preventing any movement of the tool holder relative to the support rail when the motor is not actuated, for example when the tool holder has reached its target position and as long as no other usage configuration is entered.

Thus, the preparation of the tool block for a given work is performed automatically, very quickly and without any risk of error. Thus, the downtime of the agricultural machine due to the adjustment of its tool block is significantly reduced. What is more, not only the adjustment of the position of the tools is quicker, but it is also more accurate, which guarantees achieving a quality work.

If the agricultural machine is equipped with a camera control to compensate for the drifts of the carrier to which the support rail is fastened, the disclosure also allows individually adjusting the position of each tool to compensate for these drifts, the support rail remains fixed in the machine. With a tool block of the prior art, this compensation is performed by moving the support rail laterally, which moves all tools together, and it is not possible to individually adjust the position of each tool.

It should be noted that in the case where a tool is damaged or in the event of breakdown of the motor of a tool holder, it is not necessary to unload the considered tool holder (and its tool). It is possible to simply remove the tool or the motor block from the tool holder and to equip the tool holder with another tool or motor block. Nonetheless, if the defective tool holder is the first tool holder present on the support rail starting from the loading end 22, it is rather possible to completely unload the tool holder (and its tool) and replace it with a new assembly while the defective assembly is repaired.

The disclosure is not limited to the aspect shown in the appended figures. For example, other motorised drive means may be provided instead of the fixed chain 20 and of the pinions 703, likewise, other means for positioning the tool holders relative to the support rail may be provided instead of the magnetic spacers 708 and sensor magnets 709. Still as example, it could be considered that the movement of the tool holders is directly controlled by the central control system and that the tool holders are devoid of individual control boards.

A support rail having a loading area 26 at each of its ends is also in accordance with the disclosure but is not desirable because the absence of a chain in the loading area means that this area cannot be used as a parking or work area. In order to have the same parking length, it would therefore be necessary to use a larger rail, which, of course, is not advantageous.

Other variants are possible insofar as they remain within the scope of the appended claim 1.

What is claimed is:

1. A tool block for an agricultural machine having an axial direction intended to coincide with a direction of movement of the agricultural machine, and a transverse direction according to which a width of the tool block is defined, this transverse direction of the tool block being intended to coincide with a transverse direction of the agricultural machine orthogonal to the axial direction of movement, the tool block comprising:
a plurality of tools,
for each tool, a tool holder on which the tool is mounted,
a support rail extending according to the transverse direction, on which the tools can be mounted via their respective tool holder, which tool holder comprises means for coupling to the support rail enabling a movement of the tool holder relative to the support rail according to the transverse direction, characterised in that it comprises:
a central control system with microprocessor(s),
a human-machine interface connected to the central control system and configured to enable a user to enter a usage configuration defining tools to be used among the plurality of tools of the tool block, as well as a target position on the support rail for each of the tools to be used,
the tool block comprises motorised drive means configured to move each tool holder individually according to the transverse direction on the support rail, the motorised drive means being controlled, directly or indirectly, by the central control system,
position-determining means for determining the position of each tool holder relative to the support rail according to the transverse direction.

2. The tool block according to claim 1, characterised in that the support rail comprises
a loading end and a loading section by which the tool holders can be loaded onto the support rail,
a working central section on which the tool holders of the tools to be used can be driven and positioned according to the selected usage configuration, using the motorised drive means and the position-determining means,
at least one parking lateral section, on which unused tools among the plurality of tools can be stored.

3. The tool block according to claim 1, characterised in that the motorised drive means comprise a fixed chain which extends according to the transverse direction and is integrated to the support rail, as well as, for each tool holder, a pinion adapted to engage the fixed chain of the support rail for the purpose of moving the tool holder along the support rail.

4. The tool block according to claim 3, characterised in that:
the tool block comprises, for each tool, an individual control board with microprocessor(s), housed in the tool holder on which the tool is mounted, and in which an identifier of the tool is memorised, said individual control board being connected to the central control system of the tool block,
the position-determining means comprise a calculation module integrated into the individual control board of each tool holder and one or more sensor(s) located on the support rail and/or on each tool holder.

5. The tool block according to claim 3, characterised in that the motorised drive means comprise, for each tool holder, a motor block integrating a motor configured to drive in rotation a motor shaft on which the pinion of the tool holder is fastened.

6. The tool block according to claim 3, characterised in that the position-determining means comprise, for each tool holder, a SINCOS sensor configured to transmit to the individual control board of the tool or to the central control system measurement data representative of an angle formed by a marking axis of the pinion with a fixed reference axis orthogonal to the motor shaft, the individual control board of the tool or the central control system being configured to calculate a number of complete revolutions and revolution fractions performed by the shaft motor from a gear position or from a previously memorised position and to deduce therefrom a current position of the tool holder relative to the support rail.

7. The tool block according to claim 1, characterised in that the means for coupling each tool holder to the support rail comprise a bracket having a coupling opening having a section complementary to a nominal section of the support rail, the coupling opening being equipped with rollers to enable movement of the bracket along the support rail.

8. The tool block according to claim 7, characterised in that the rollers comprise an adjustable roller whose radial position relative to the rail is adjustable and which is subjected to a centripetal return force.

9. The tool block according to claim 3, the fixed chain having a first end, so-called the engaging end, on the side of the loading end of the support rail, characterised in that the position-determining means comprise, on the one hand, an inductive proximity detector on each tool holder and, on the other hand, at the engaging end of the chain, a sensitive element able to be detected by the proximity detector of each tool holder.

10. The tool block according to claim 1, characterised in that each tool holder includes an end-of-travel sensor or switch on an upstream lateral face of the tool holder oriented towards a parking end of the support rail.

11. An agricultural machine equipped with a tool block according to claim 1.
